(19) United States
(12) Patent Application Publication
(10) Pub. No.: US 2013/0089718 A1
(43) Pub. Date: Apr. 11, 2013

(54) CUT-TO-SIZE FORMAT

(71) Applicants: Philipp Schaefer, Hannover (DE); Matthias Rolf, Hannover (DE)

(72) Inventors: Philipp Schaefer, Hannover (DE); Matthias Rolf, Hannover (DE)

(73) Assignee: LANXESS DEUTSCHLAND GMBH, Leverkusen (DE)

(21) Appl. No.: 13/704,659

(22) PCT Filed: Jun. 15, 2010
(86) PCT No.: PCT/EP2010/003588

§ 371 Date: Dec. 17, 2012

(51) Int. Cl. D06N 3/14; B32B 7/12; B32B 27/40

(52) U.S. Cl. CPC D06N 3/14; B32B 27/40; B32B 7/12
USPC 428/206; 428/212; 428/195.1

(57) ABSTRACT

The invention relates to a cut-to-size format comprising a more particularly sheeting-shaped or layer-shaped backing material (2) comprising a fibrous nonwoven web and/or loop-formingly knitted and/or woven fabric comprising polyamide and/or polyester threads, more particularly polyamide and/or polyester microfibers and/or cotton threads and, applied atop the backing material (2), a coating (4) comprising polyurethane dispersion on a patterned silicone rubber support/mold attached to the backing material (2), optionally via an adhesive layer (7) comprising polyurethane dispersion.

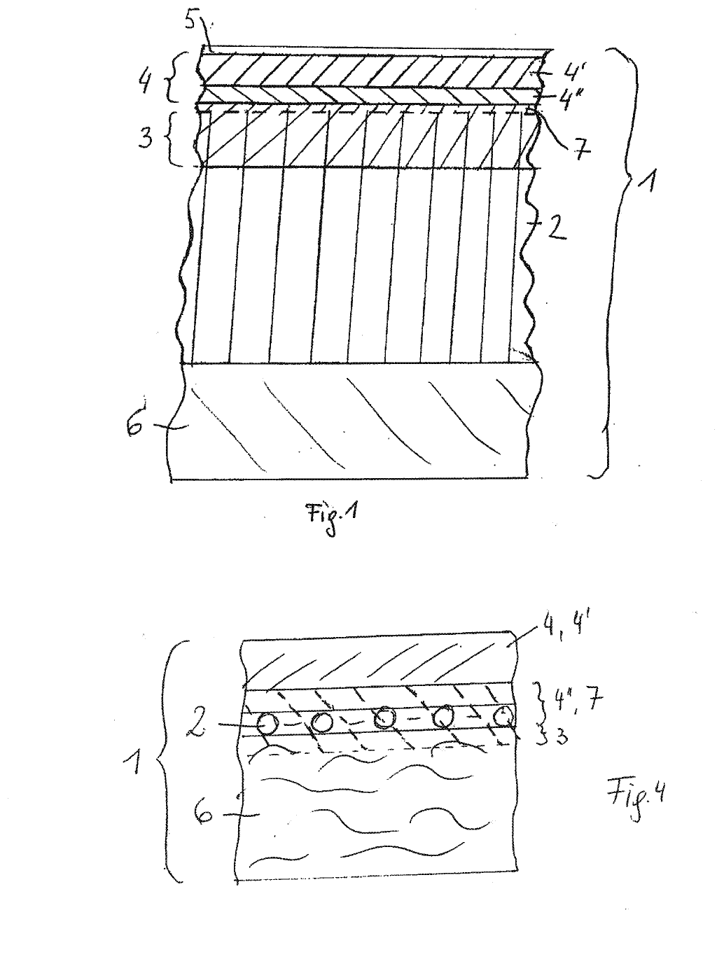

The invention provides that the entire polyurethane content of the cut-to-size format (1) is in the range from 60 to 240 g/m², this basis weight also including any polyurethane already present in the backing material (2) or introduced thereinto in the course of production thereof, and the basis weight of the backing material (2), in particular where applicable any polyurethane present therein, is in the range from 200 g/m² to 450 g/m² (FIG. 1).

The invention relates to a cut-to-size format as classified in the preamble of claim 1.

DE 26 08 781 C2 discloses a leatherlike substrate with a textile backing body impregnated with a polymeric foam. This backing body consists of a fibrous nonwoven web or loop-formingly knitted fabric impregnated to between 20 and 60% of its overall thickness starting from its surface. The polymeric foam has open cells formed by introduction of air and also contains closed cells formed by hollow microspheres. There is a thin coating of PU on the buffed surface. This backing has a high carbon content due to the CO₂ gas in the hollow microspheres; the material is hard/harsh, i.e., its haptics leave something to be desired. To obtain a nubucklike appearance, the surface has to be buffed after substrate coating.

DE 200 10 978 U1 discloses a substrate with a surface coating of a crosslinked layer of polyurethane, bonded to the surface of the substrate by a layer of adhesive. The main disadvantage with this substrate is that folding leaves noticeable creases, and that there is no defined degree of penetration for the applied coating into the backing material.

In DE 20 2004 004 807, a foundational body, which is constructed from fibrous material, has a polymeric coating. The foundational body consists of at least two layers, of which the backing body layer which faces the coating is formed by a nonwoven web of microfibers wherein the void spaces between the microfibers are at least partly filled by a coagulated polymeric material. A substrate of this type contains a considerable amount of polyurethane and the amount of polyurethane used to bond the two fibrous nonwoven webs together comes close to the amount of polyurethane used for producing the coating.

In DE 203 18 906 U1, a thin coating is applied atop a backing and tends to float in that the coating is applied atop the rough surface of the backing and there is no provision for the coating to penetrate into the backing.

The invention has for its purpose to provide a cut-to-size format which even in a thickness of 1 mm or more combines low weight with outstanding mechanical properties, especially sustained flexibility even at temperatures below zero. The cut-to-size format shall further possess abrasion resistance, color and light fastness and tensile strength and more particularly substantially equal extensibility and tensile strength in mutually orthogonal directions. The cut-to-size format shall further possess a coating appropriate to its intended use, and the coating may either be largely waterproof, for example for motorbike seats, seat covers or luggage, or water vapor permeable, for example for automotive interior trim, upholstered furniture covers and also shoe upper material. The cut-to-size format shall further not allow the structure of the textile backing material to be visible on the fine, soft and thin coating in a conspicuous manner, if at all, while the coating shall be durably bonded to the textile backing material. The cut-to-size format of the invention, when it is touched with the hand or rests against the body, shall—unlike conventional sheeting-type artificial leathers having a heavy thick coating—also quickly adapt to the body temperature and/or provide temperature equalization to ensure improved haptics and enhanced comfort.

Furthermore, the thin coating applied atop the textile backing material shall not form a crease fold on bending, even when being bent around an acute angle, as is the case when there is a thin coating on a light bulky fibrous nonwoven web backing, or when a thin coating is floating atop a fibrous surface. One of the most important objects is to provide a textile backing with a coating which particularly exhibits a textile and/or nubucklike fine structure.

It is also a further important object that the cut to size formats can be fabricated in small amounts, without costly and inconvenient tools, with particular surfaces desired by the market in respect of appearance, haptics and friction on different backing materials cut out of sheeting. It is a further important object to provide a cut-to-size format which meets the vehicle industry's limits with regard to carbon emissions and which has a favorable CO₂ balance at its time of production even if regard is had to all components used—and this coupled with low water requirements.

These objectives are achieved by a cut-to-size format of the type mentioned at the outset as a result of the entire polyurethane content of the cut-to-size format being in the range from 60 to 240 g/m², preferably in the range from 80 to 150 g/m², and especially in the range from 100 to 140 g/m², this basis weight also including any polyurethane already present in the backing material or introduced thereinto in the course of production thereof, and as a result of the basis weight of the backing material including any polyurethane contained therein being in the range from 200 g/m² to 450 g/m², preferably in the range from 200 g/m² to 350 g/m² and especially in the range from 230 g/m² to 270 g/m².

The cut-to-size format of the invention is lightweight, robust and possesses extensibility and strength, which are essentially homogeneous/similar in mutually orthogonal directions on its surface. The haptics of the surface are pleasant and the surface can be patterned/textured in almost any desired manner. The use of polyurethane dispersion is low and hence the cut-to-size format is obtainable in an inexpensive manner.

The backing material based on a fibrous nonwoven web may already contain a small amount of polyurethane to consolidate the web. But this polyurethane has a spongy texture and therefore is very light. This polyurethane content must be considered very low, amounting to less than 70 g/m² for a backing thickness of 0.9 mm.

In practice, the entire polyurethane content of the cut-to-size format is easy to ascertain, viz., by dissolving out the polyurethane with dimethylformamide and weighing the cut-to-size format before and after the polyurethane is dissolved out.

The basis weight chosen for the textile backing material ensures a robust yet simply and inexpensively obtainable foundation and can be readily bonded to the coating. Any other polymeric dispersion admixtures, such as polyacrylates or resins for example, become dissolved out as well and count as polyurethane.

It is advantageous when the coating, which is more particularly applied in the form of a film, has a basis weight in the range from 60 g/m² to 240 g/m² and in special cases from 60 g/m² to 160 g/m². Inclusive of the adhesive layer embedded in the backing material and of any polyurethane introduced in the backing body during its production, the amount is sufficient to cover the texture of the backing material such that this texture appears prestigious to an observer, or does not have any noticeable influence on the pattern formed on the surface of the coating even on elongation, and that even very fine textile fiber structures, as of carbon fabric for example, are exactly reproduced.

To enhance the adherence of the coating and/or to improve the haptics of the cut-to-size format, it may be provided that the fibrous nonwoven web or loop-formingly knitted or woven fabrics are in a tumbled and/or lightly roughened state, optionally emeried with a grit size >400, especially with a grit size of 450 to 900, in order to eliminate nodules and elevations that might become apparent on the surface of the coating.

It is advantageous for the strength of the textile backing and the durability of the applied coating when the backing material comprises visually dense, i.e., scarcely or non-transparent and/or scarcely or non-translucent loop-formingly knitted or fibrous nonwoven web or woven fabrics or a bonded assembly of loop-formingly knitted fabric/fibrous nonwoven web fabric or loop-formingly woven fabric/fibrous nonwoven web fabric.

It has transpired that it is particularly advantageous for the loop-formingly knitted or woven fabric to consist of cotton or at least contain cotton threads and for the coating side to evince a very slight fleece effect due to flexing or buffing. The best results are achieved not only in relation to the production process but particularly in relation to ready-produced cut-to-size formats when the loop-formingly knitted or woven cotton fabric has a basis weight between 100 and 200 g/m² and the fibrous nonwoven web to which the cotton fabric is bonded likewise has a basis weight between 100 and 200 g/². Especially when a fibrous nonwoven web of this type consists of polyester or polyamide fibers, it may be advantageous for these fibers to have a linear density between 2 and 6 denier.

The cotton is quick to imbibe the polyurethane dispersion water and conducts it to the non-absorbent synthetic fibers. This simplifies the manufacturing operation and reduces drying energy requirements. But the main advantage with this bonded combination assembly is that adhering the very slightly fleecy surface of the loop-formingly knitted or woven fabric to the layer 4′ causes the very fine structures, transferred from the die to the coating surface, to be absolutely exactly preserved even on elongation. This advantage is the result of the fine short fleece fibers in the layer 4″ or in the adhesive layer 7 being horizontal/parallel to the surfaces and eliminating unevenness and backing structures, especially when the backing 2 is laid into the wet layer 4″ and pressed down lightly. The fibrous nonwoven webs having a fiber linear density in the denier range comprise a three-dimensional arrangement of fibers. The fibers are mutually consolidated either using hydroentangling or preferably by needling and may have undergone thermal shrinkage. In this case, it is important that they be soft and bulky, combining a weight between 100 and 200 g/m² with a thickness between 0.8 to 1.8 mm. The loop-formingly knitted or woven cotton fabric may either be adhered to the fibrous nonwoven web; preferably, the cotton fabric is bonded by needling to one side of the fibrous nonwoven web even as the fibrous nonwoven web is being formed. Such a bonded assembly is durable and inexpensive and does not require any further adhesive materials. This bonded assembly possesses an extremely high tongue tear strength, which is important for the envisioned applications of the cut-to-size format. To be able to adapt the cut-to-size format to different uses, it may be provided that the side of the backing material which is remote from the coating has at least one further layer, preferably comprising a light, bulky, preferably 3 to 6 mm thick, fibrous nonwoven polyester or polyamide web adhered to or laminated onto it with a foamed polymeric dispersion adhesive. It may also be provided for this purpose that the further layer comprises a bonded assembly formed by a needlefelt or fibrous nonwoven polyester/polyamide web or a layer of a peelable polyurethane foam or a chloroprene-polymer foam with a loop-formingly knitted fabric and attached to the reverse side of the backing material, which is preferably formed by a loop-formingly knitted fabric.

It may be advantageous when the peelable polyurethane foam or the polychloroprene possesses a density of 0.005 to 1.2 g/cm³, preferably 0.01 to 0.06 g/cm³, and/or when the needlefelt possesses a basis weight of 100 to 200 g/m², preferably 120 to 160 g/m², and an average thickness of 2 to 4 mm, preferably 2.5 to 3.5 mm, and/or when the loop-formingly knitted fabric which forms the reverse side possesses a basis weight of 60 to 160 g/m², preferably 80 to 120 g/m², especially 80 to 100 g/m².

The peelable polyurethane foam and the polychloroprene foam are effectively interchangeable. More particularly, cut-to-size formats of this type can be used for the production of cushioning, since a compliant and soft/shock absorbing cut-to-size format of the type useful for example in motor vehicle cushioning, especially in inner roof liners, and which unlike bulky polymeric foams has a very low total carbon emission value can be produced in this way.

It has transpired that it is advantageous for the backing material to comprise not more than 30 wt %, preferably not more than 20 wt %, of the total amount of solidified polyurethane dispersion present in the cut-to-size format, and/or for the regions of the material into which the polyurethane dispersion have penetrated in a controlled manner on application to have a density which is between 15% and 55% above the density of the polyurethane dispersion-free regions of said backing material, resulting overall in an efficiently bonded assembly of low weight.

An advantageous construction of the cut-to-size format is achieved when the coating is constructed with two inseparably interconnected layers and comprises a surficially positioned, surficially patterned layer comprising polyurethane dispersion, and a layer thereunder and connected therewith and comprising a polyurethane dispersion which possesses a linear structure and optionally contains polyacrylates and/or synthetic resins, wherein there is an adhesive layer comprising polyurethane on the surface of the backing material, which adhesive layer has penetrated into the backing layer by between 0.02 and 0.6 mm and preferably by between 0.05 to 0.4 mm, and increases the density of the backing layer in this region by 15 to 55 wt % relative to the remaining regions of the backing layer. This provides a highly tenable coating which can achieve effective anchoring in the fibers or void spaces of the backing material. A highly tenacious adhesive layer is obtained when the adhesive layer comprises a polyurethane dispersion layer having a basis weight of 20 to 80 g/m² and optionally containing polyacrylates and/or resins, and optionally possesses the same chemical construction as the polyurethane dispersion layer to be bonded to the backing material.

Elevating the density of the backing layer in the penetration region of the polyurethane adhesive dispersion by from 15 to 55 wt % and preferably by from 20 to 35 wt % ensures in particular in the case of backing layers formed from loop-formingly knitted fabrics not only a firm bond to the adhesive layer but also that, even in the event of severe elongation in both directions/by mutually orthogonal directions by 15% for example, the textile structure of the loop-formingly knitted fabric does not become visually noticeable on the surface of the thin soft coating and even the very fine structures of carbon fibers, for example, are not distorted. The controlled penetration of the polyurethane adhesive dispersion, by between 0.02 to 0.6 mm and preferably by between 0.05 to 0.4 mm, into the backing layer is policed by employing a slight pressure using an applicator roll for example when applying the dispersion to the upper side of the backing layer, in which case the gap between the rolls is narrower by the desired penetration depth than the thickness of backing material and adhesive layer. An adhesive layer appropriately introduced into the backing material can also be formed using a correspondingly applied area or roll screen print, but preferably by airless spraying at a line pressure of more than 60 bar. Particularly soft coatings are obtained when this adhesive dispersion, or the density-elevated polyurethane dispersion, is used in the form of a mechanically blown foam having a density between 0.75 and 0.95 g/cm³.

The polyurethane dispersion of the adhesive layer is preferably applied in a controlled manner, or to be more precise the dispersion/adhesive layer penetrates into the backing layer in a controlled manner particularly in the case of very soft textile backings, such as polyurethane-free fibrous nonwoven webs or thin, open-mesh loop-formingly knitted fabrics or thin open-mesh woven fabrics bonded to a thicker fibrous nonwoven web. In the matrix, the largely dry first layer applied therein has the second layer directly sprayed onto it and then the backing material is laid onto this still wet second adhesive layer and pressed down lightly. The depth of penetration of the dispersion of this layer into the backing layer is easily controlled/adjusted via the spray-applied dispersion quantity, its viscosity and the choice of light downward pressure after the backing has been placed onto/into the wet dispersion. It is very advantageous in accordance with the present invention for the wet dispersion of adhesive to penetrate through the open meshes of the thin, lightweight loop-formingly knitted or woven fabric into the surface of the fibrous nonwoven web, resulting in the loop-formingly knitted or woven fabric becoming embedded in the solidified dispersion. This overall coating construction, in which all polyurethane layers are applied directly to the die, leads to the cut-to-size format becoming more homogeneous and being largely waterproof.

According to the present invention, an even better bond is obtained when the loop-formingly knitted or woven polyester fabric or the loop-formingly knitted or woven polyamide fabric contains between 10 and 45 wt % and preferably between 20 and 30 wt % of cotton threads. A mixture of this type additionally offers the processing advantage that the cotton threads rapidly imbibe some of the dispersion water and that the adhesive dispersion in/on the backing layer dries more quickly.

An attractive surface is impartable to the cut-to-size format when there is a pattern on the outside surface of the coating, wherein the patterned coating especially has the appearance of fine-structured textile surfaces and/or a nubucklike appearance. The appearance of buffed rubber, emery paper or waffling or of an industrial fabric, for example a loop-formingly woven or knitted fabric comprising glass or carbon fibers, or a technical appearance or an appearance like grained leather can also be provided.

For protection, it may be provided that the surface of the coating has a very thin, hydrophobic finish layer in a thickness of less than 0.005 mm with nanoparticles of polysiloxane or of wax or of fluoropolymers or of mixtures thereof.

An inexpensive and environmentally friendly construction of the cut-to-size format, for example for automotive roof liners, is achieved when the reverse side of the backing layer has a bulky, light up to 6 mm thick fibrous nonwoven polyester web containing threads/fibers comprising PET bottle regenerate attached to it with a foamed dispersion adhesive.

The coating is applied to a sheetlike, layer- or plate-shaped cut-to-size piece of a backing material such that the coating is formed either with or on a negatively patterned support/mold of silicone rubber by solidifying a polyurethane-containing dispersion onto which a polyurethane-containing dispersion layer is applied. This dispersion layer is adhered preferably using heat and/or pressure after its consolidation on the silicone support to the adhesive layer which is on the backing layer and which is preferably chemically identical or very similar and can be foamed. The outside surface of the coating is produced/patterned by the die. The coating is bonded to the adhesive layer by the still moist adhesive layer on the backing material being placed onto the coating and the layers being bonded together at a pressure of less than 0.3 kg/cm² and preferably less than 0.15 kg/cm², or largely pressurelessly and at a temperature of less than 80° C. and preferably less than 65° C.

An alternative and preferred possibility is for the second layer, i.e., the adhesive layer, to be applied not to the textile backing, i.e., the textile backing layer, but directly to the solidified first layer of the coating and for the backing to be placed into/onto this wet layer, pressed down lightly and thermally dried and adhered.

A cut-to-size format of this type is advantageously configured such that the overall basis weight of the cut-to-size format is between 250 and 500 g/m² and especially between 350 and 450 g/m² when the overall thickness is in the range from 0.9 to 1.5 mm.

Pleasant haptics result when the coating comprises a polyurethane dispersion having a hardness of less than 68 Shore A and preferably of less than 55 Shore A.

The backing material has the appropriate lightness, a higher bulk, better haptics and a softer hand when a fleecy fibrous structure has been formed on its reverse side. The yarns of the loop-formingly knitted or woven fabric consist of polyester or polyamide and may also contain up to 40 wt % of cotton or be formed using cotton threads only. Fibrous nonwoven polyester or polyamide webs have a more than 20% lower basis weight than comparable loop-formingly knitted or woven fabrics for a given thickness and yet have a higher tongue tear resistance and a better stretching behavior. Especially the costly microfiber nonwoven webs having a sponge-type polyurethane impregnation lead on coating by the method of the present invention, and even if the basis weight is as low as 240 g/m², to optimal cut-to-size formats having a thickness of 1.1 mm and an overall basis weight of 310 g/m². These fibrous nonwoven webs comprise fiber having a linear density of about 0.7 dtex.

But, according to the present invention, even the very inexpensive fibrous nonwoven polyester or polyamide webs having a fiber linear density between 1 and 9 denier and preferably from 2 to 4 denier can be used to produce cut-to-size formats which are very close to those formed from microfibers and in terms of their low weight are even superior to them. Particularly good results are obtained in terms of a very exact surface structure reproduction which does not change even on elongation by 15% and where even the finest fibrous structures of a copied carbon fabric remain three-dimensionally undistorted in the thin coating in a manner which is typical of carbon fiber. This is achieved as a result of a thin, light, open-mesh loop-formingly knitted or woven polyester or polyamide fabric being embedded in the adhesive/polyurethane layer between the coating and the fibrous nonwoven web. Good durability and robustness are obtained for the coating when the patterned top layer of the coating having a consolidated polyurethane dispersion mixture is produced, which contains between 2 and 10 wt % of non-emigratable polysiloxane and is crosslinked. The coating layer which is at the bottom in the cut-to-size format and also the adhesive layer bonded to the backing material may each comprise from 50 to 85 wt % of crystalline polyurethane. The adhesive layer on the surface of the backing material has entered/soaked into the absorbent material of the fibrous nonwoven web material, if present through a meshed loop-formingly knitted or woven fabric, from the surface of the backing layer to a depth of from 0.02 to 0 6 mm and especially from 0.05 to 0.4 mm.

A particularly important feature of the present invention is that all layers contain a crosslinker and that these layers are brought together, or laid on top of each other, before the crosslinker takes effect, so that crosslinking takes place at the same time in all layers. Hence the layers undergo crosslinking within themselves and also with other layers; that is, crosslinking is not just concurrent crosslinking of individual layers but also takes the form of a transverse crosslinking beyond any one layer. Therefore, to produce the cut-to-size format, the adhesive layer soaked into the backing material has applied to it the adhesive layer bonded to the surface layer, and so the two adhesive layers adhere to each other. What is helpful here is for the coating and/or the adhesive layer to each contain up to 50 wt % and preferably up to 25 wt % of polyacrylates based on the polyurethane content of the dispersion.

It is advantageous for good bonding when the thickness of the coating comprising the surface layer and the layer adherent thereto is from 0.05 to 0.16 mm.

The adhesive layer has been applied atop said backing material from the surface at a weight of 20 to 80 g/m² and has become at least partly incorporated therein.

The invention lastly also provides articles obtained using a cut-to-size format of the present invention, especially in the form of motor vehicle inside wall lining e.g. automotive roof liner and cushioning, bags, suitcases, furniture covers, garments, shoes, bicycle or motorbike saddles or map cases. It is advantageous to use the cut-to-size formats of the present invention to produce these articles.

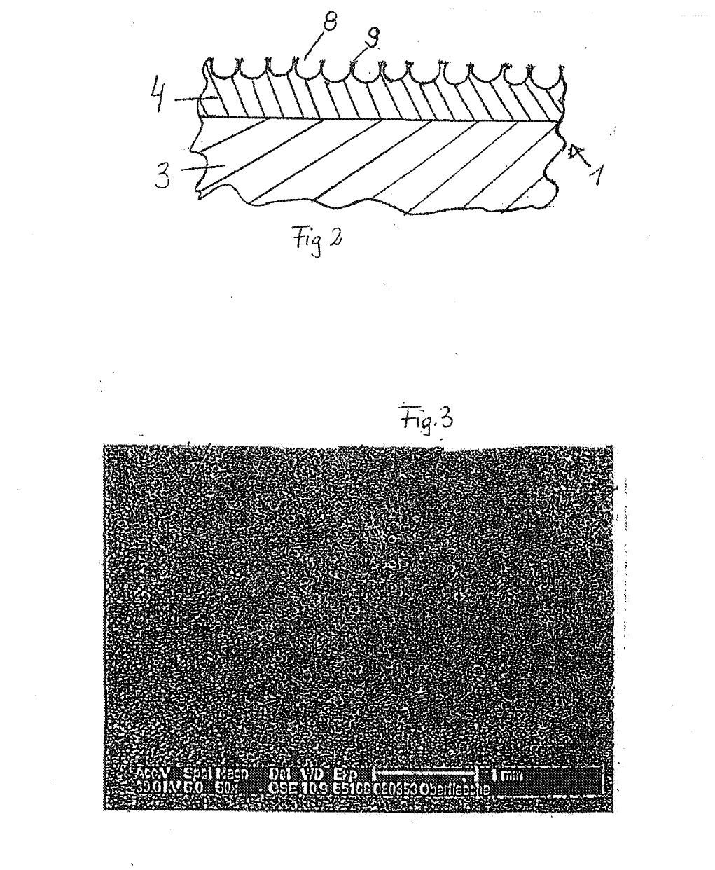

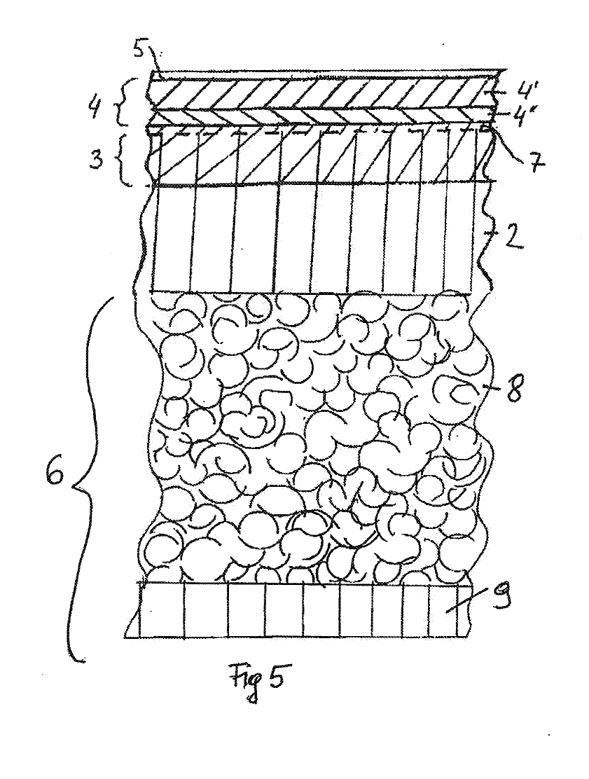

Exemplary embodiments of the invention will now be more particularly elucidated using the drawing, in which FIGS. 1 and 2 depict a schematic section through the construction of a cut-to-size format of the present invention. FIG. 3 shows a plan view of the surface of a cut-to-size format of the present invention. FIG. 4 shows an advantageous embodiment of a cut-to-size format of the present invention. FIG. 5 shows a cut-to-size format wherein the backing material is bonded to a further layer.

The cut-to-size format of the present invention includes a layer of textile backing material 2 comprising a fibrous nonwoven web and/or a loop-formingly knitted or woven fabric comprising polymeric fibers, especially polyester fibers. A fibrous nonwoven web may also have positioned on top of it for example a thin, open- or wide-meshed loop-formingly knitted or woven fabric constructed using synthetic threads or cotton threads which is not depicted here.

Particularly soft and thick end products utilize fibrous nonwoven webs having a fiber linear density between 0.7 dtex and 9 denier.

The loop-formingly knitted or woven fabrics used may be tumbled and/or lightly buffed to a fleecy state, on its coating side, in particular emeried with a grit size >400, preferably with a grit size of 450 to 900, and preferably have a pronounced fleecy texture on their reverse side.

An adhesive layer 7 has been applied directly or indirectly atop the layer of backing material 2, or to be more precise has largely soaked into the layer of backing material 2. This adhesive layer 7 has had applied to it a coating 4 which comprises two layers, viz., a patterned, surficially positioned surface layer 4′ and thereunderneath a layer 4′ used for adhering. The coating 4 has been applied atop the adhesive layer 7 such that the adhesive layer 4″comes to rest on the adhesive layer 7 and these two layers 4″ and 7 become bonded together in an indissoluble manner. A finish layer 5 may be applied atop the outside surface of the top-lying layer 4′ of coating 4.

The coating 4 including the polyurethane in backing material 2 and any in adhesive layer 7 contain no solvent in the same way as the backing material does not. The cut-to-size format is thus very largely free of carbonaceous emissions and was also produced in an environmentally friendly manner, including with very low consumption of water.

The entire polyurethane content of the cut-to-size format 1 is in the range from 60 to 240 g/m², preferably in the range from 80 to 150 g/m² and especially in the range from 100 to 140 g/m². This recited basis weight also comprehends any polyurethane already present in backing material 2 as a result of polyurethane dispersion already incorporated in backing material 2 in the course of the production process thereof.

What results according to the invention is a basis weight for the cut-to-size format including the coating 4 and the backing material 2 in the range from 250 g/m² to 500 g/m² and preferably in the range from 350 g/m² to 450 g/m².

This results in good bonding between the coating 4 and the backing material 2. However, it is envisioned overall that the backing material 2 contains at most 20 to 80 g/m² of polyurethane dispersion, this content including not only any polyurethane already introduced in the course of producing the backing material 2 but also the polyurethane dispersion which has penetrated into the region 3 in the course of applying the coating 4.

The surface of said coating 4 may have a very thin, hydrophobic finish layer 5 in a thickness of less than 0.005 mm with nanoparticles of polysiloxane or of wax or of fluoropolymers or of mixtures thereof.

The coating 4 is constructed with two inseparably interconnected layers 4′ and 4″ and comprises the surficially positioned, patterned layer 4′ comprising polyurethane dispersion, and the layer 4″ thereunder and connected therewith and comprising a polyurethane dispersion which possesses a linear structure and optionally contains polyacrylates and/or synthetic resins. This polyurethane dispersion layer 4″ is bonded to the polyurethane adhesive layer 7 on the backing material 2 as long as this layer or these layers is or are still moist or wet. It is provided that the coating 4 has been formed using a negatively patterned support/mold of silicone rubber by solidifying a polyurethane-containing dispersion bonded/adhered to the surface of backing material 2 or to the adhesive layer 7. The coating 4 is produced/patterned by this die and applied while still in the moist state, more particularly largely pressurelessly and with only minimal temperature elevation.

The layer 4′ of coating 4 is formed/molded beforehand with a polyurethane dispersion on a heated/hot silicone support and solidified by drying; the layer 4″, which has a chemically identical or very similar construction, is applied atop. The layer 4″ becomes firmly bonded to the soft adhesive layer 7, which is likewise chemically identical or very similar to coating 4.

It is envisioned that the basis weight of a cut-to-size format which is in accordance with the present invention is between 320 and 485 g/m² when the final thickness is about 1.2 mm, as is preferred.

Since the fibers of backing material 2 preferably consist of polyester, the requirements of the vehicle industry, especially with regard to the evolution of organic compounds, are not just satisfied but considerably exceeded. The cut-to-size blank of the present invention has a favorable CO₂ balance.

A cut-to-size format of this type further has a breaking extension of more than 20% and preferably of more than 40% in mutually orthogonal directions in the sheet, or a 15% elongation does not produce any noticeable change in the surface.

To be able to produce thicker cut-to-size formats 1, the coating-free or reverse side of the backing materials 2 can have applied to it a further layer 6 which is formed by a fibrous nonwoven web. It is also possible for two or more layers 6 to be applied. Such an arrangement is shock absorbing and/or has outstanding sound-deadening and safety properties. Since the fibers can be regenerated/recycled from PET bottles, production of such fibrous nonwoven webs is economical and environmentally friendly.

Whether the adhesive layer 7 is applied directly or indirectly, some of this dispersion will penetrate in a controlled manner into the backing material 2 and into the region 3, which is from 0.02 to 0.6 mm and preferably from 0.05 to 0.4 mm in thickness. A thin, torn film of adhesive less than 0.02 mm in thickness develops in the process on the surface of the backing material when the adhesive dispersion was applied thereto directly. When the adhesive dispersion indirectly, i.e., when the backing layer is placed in the wet dispersion, a largely homogeneous film develops on the backing surface. In said region 3, where the dispersion has penetrated, the backing material 2 has a density after the dispersion has dried that is between 15 and 55% above the density of the backing material 2 region into which no polyurethane dispersion has penetrated. Waterproofness and water vapor permeability can be influenced/controlled by applying the adhesive dispersion to the backing layer directly or indirectly. When the cut-to-size format 1 has a preferred final thickness of 1 mm, its weight is between 290 and 385 g/m². Thickness was measured in line with DIN 53326 using a gauge diameter of 25 mm and a spring pressure of 5 N.

The finer the fibers forming the yarns, the greater the number of fibers needed and the greater the resulting surface area of the yarn or of the microfibers used for the fibrous nonwoven web, and better the resulting bond between the polyurethane dispersion and the yarn or, respectively, the microfibers of the fibrous nonwoven web.

The cut-to-size formats are produced more particularly by providing the backing material 2 in the form of sheeting and cutting appropriate blanks in a length of two meters and a width of 1.5 meters for example and applying the coating 4 to these sheetlike or plate-shaped backing materials. This coating 4 is transferred to the plate-shaped backing material 2 from the or directly with the silicone rubber die.

The coated surface 4 of a cut-to-size format 2 may have differing appearance and differing functionality in different areas. For instance, one sub-area of the cut-to-size format might have the appearance and properties of a carbon fiber fabric and possess only minimal water vapor permeability, while another sub-area of the cut-to-size format has an appearance resembling nubuck leather and a significantly higher water vapor permeability.

It is important and particularly advantageous for the two layers 4 and 4′ of coating 4 to be fabricated on the die. The backing material 2 part to be bonded/adhered to this coating 4 is the adhesive layer 7, which has been applied to the backing material 2 directly or indirectly and which has soaked into the backing material 2. Some or a large portion of this adhesive layer 7 has become incorporated as defined in region 3 of the backing material to increase the density thereof in a controlled manner. This construction is an optimal solution to the stated problems. It may be provided according to the present invention that, for further improvement, the adhesive which forms part of the adhesive layer 7 and which alters the density of backing material 2 in region 3 along its penetration depth has been foamed up and has become incorporated as a mechanically blown foam with a corresponding amount of introduced air.

The introduced adhesive layer 7 and this layer's dispersion which has been introduced into the backing material 2 have a dual purpose. The adhesive layer 7 serves to increase the density of backing material 2 without filling the void spaces/interspaces in the yarn masses/fibers or cells of any sponge structure already present in backing material 2, but also avoids any sealing of existing interspaces and a higher overall weight resulting therefrom. It also has the best adhesive properties.

To obtain optimal crosslinking between the individual layers, it is advantageous when the first layer 4′, which is produced on the patterned die, still contains 0.2 to 4 wt % of water and preferably has a water content of 1 to 3 wt %, based on the solids content of the polyurethane dispersion. The dispersion is applied thereto wet-on-wet to form the adhesive layer 4″. This applied dispersion is dried and still contains between 0.5 and 6 wt % of water based on the solids content of the polyurethane dispersion.

The polyurethane adhesive layer 7 applied atop the backing material 2, or to be more precise the dispersion used therefor, is applied moist with a water content between 4 and 25 wt %, based on the solids content of the polyurethane dispersion, and the layers 4″ and the adhesive layer 7 are placed against each other, for example by placing the adhesive layer 7 with the backing material 2 onto the coating 4 formed in the die. The layer 4″ and the adhesive layer 7 are bonded together using minimal pressure and any necessary minimal heating.

At this point of bonding the backing material 2 with its still moist adhesive layer 7, this adhesive layer 7 is still extremely soft and manipulable/modifiable by pressure. The layers 4′ and 4″ on the die are also still uncrosslinked and contain residual water and are likewise still very pressure sensitive before crosslinking. Accordingly, polyurethane dispersions which contain synthetic resins or are what is known as resin modified are used according to the present invention.

The layers 4″ and 7 which, before their crosslinking, have pronounced contact-adhesive properties at normal or at temperatures below 80° C., are readily adherable to each other. Resin additions of this type are in a range between 2 to 9 wt % based on the weight of the polyurethane dispersion. The use of a polyurethane dispersion having contact-adhesive properties at room temperature or at temperatures below 80° C. is important because the coating 4 is still uncrosslinked at the time the layers are pressed/joined together and contains residual water and thus is very pressure sensitive. At elevated pressures and at elevated temperature for activating the adhesive, the structure of backing material 2 could become very noticeably apparent on the coating surface, but this can be avoided by appropriate process management.

The polyurethane dispersion mixtures used to form the coating 4 and/or the adhesive layer 7 could include additives, especially pigments, crosslinkers or thickeners. These additives increase the solids content of the polyurethane dispersion to 38-54 wt %, based on the weight of the dispersion. The water content of the polyurethane dispersions used is between 46 and 62 wt % of the dispersion.

In indirect coating, which is preferred, the adhesive dispersion 4″ is applied atop the dry layer 4′. The adhesive layer 4″ in the die has to be still wet at the time the backing material 2 is placed on or into it, or the dispersion used should still have more than 75% of its initial water content.

After drying and final ultimate crosslinking, the polyurethane dispersion mixtures for the layer 4′ have a hardness of less than 68 Shore A and preferably of less than 55 Shore A. The layer 4″ and the adhesive layer 7 advantageously have a hardness of less than 48 Shore A and preferably between 20 and 35 Shore A.

A cut-to-size format having a lower final thickness may preferably be constructed using a backing layer 2 of a loop-formingly knitted or woven fabric having a basis weight between 40 and 100 g/m², which layer has been bonded to a fibrous nonwoven web having a basis weight between 80 and 240 g/m² and preferably 110 to 180 g/m². Advantageously, the loop-formingly knitted fabric, the woven fabric and/or the fibrous nonwoven web are in the form of sheeting, which layers have been bonded to each other in a manner resistant to manipulation. The coating side of such a bonded textile assembly is always the loop-formingly knitted or woven fabric layer.

The textile backing material 2 may optionally be treated with chemicals to improve textile hand and softness, examples being silicones and/or surface tension effect chemicals. The backing layer 2 may also contain chemicals to influence the fire behavior. The weight fractions thereof shall not be taken into account in the present parametric recitations concerning the weights of applied layers and of backing material with regard to the recited overall weights etc.

FIG. 2 shows a magnified section through a cut-to-size format 1 and reveals a possible surface pattern on coating 4 which was lifted off the silicone die. The surface has a pattern comprising microdepressions 8, while there are struts or land regions 9 between the microdepressions 8, forming a rough/matte and finely-fibered surface. FIG. 3 shows a magnified plan view of such a surface of a cut-to-size format which is in accordance with the present invention. It is evident that the particular microdepressions 8, which have a closed border in themselves, are not wholly regular and can have different rounded but also at most polyhedral shaping.

The backing layer 2 may be constructed using wovens, formed-loop knits or fibrous nonwoven webs. The backing layer 2 may also be constructed using two different textiles bonded together, for example a loop-formingly knitted fabric bonded to a fibrous nonwoven web or a woven fabric bonded to a fibrous nonwoven web.

When the backing layer 2 consists of two different layers bonded together, the coating 4 is applied to the less extensible textile material or loop-formingly knitted or woven fabric and the fibrous nonwoven web used is always situated on the cut-to-size format's under side, or side remote from the coating 4. The fibrous nonwoven web is the softer and lighter part of backing materials 2. This has a positive influence on the haptics and prevents permanent creases forming in the event of sharp bending. Above all, however, even the fine surface structures remain unaffected on elongation by 15%.

It may be advantageous for the wovens or formed-looped knits of the backing layer 2 to have a highly pronounced fleecy fibrous structure on their face remote from the coating 4. This configuration on this face is different to the configuration on the coated side of backing layer 2, since a highly fleecy surface there would lead to a “floating” coating, whereas a very slight fleece effect on the coating side is especially advantageous in the case of formed-loop knits or wovens comprising cotton threads.

The basis weight of backing material 2 is advantageously in the range from 200 g/² to 350 g/m². However, it is readily possible to provide cut-to-size formats having a basis weight of 200 g/m² to 450 g/m² and to achieve good haptics and a correspondingly high final thickness of 1.2 to 1.5 mm at this basis weight also. A fleecy appearance similar to velvet or plush may advantageously be provided for this on the reverse side belonging to a backing layer produced using loop-formingly knitted or woven fabric and lying opposite the coating 4. Since this fiber content only increases the final thickness, it may be advantageous to use a loop-formingly knitted or woven fabric having a basis weight between 350 and 400 g/m² to achieve greater thickness, in which case the weight of the fibers protruding from the reverse-sided face can alone be as high as 120 g/m². Although this fiber weight fraction does not contribute to tensile strength and tongue tear strength, it does lead altogether to a significant improvement in the haptics and prevents a permanent crease resulting from a sharp bend.

When the backing material is formed using loop-formingly knitted or woven fabrics which are not fleecy and/or not velvet- or plushlike, the basis weight is generally in the range from 200 to 350 g/m².

The layers 4 and 4″ are generally applied by spraying the polyurethane dispersion onto the die using what are known as airless processes in particular. The dispersion to form the adhesive layer 7 can either be sprayed airlessly directly onto the layer 4″ while it is still just moist but dry to the touch, or else be applied by pouring on. The backing layer 2 is placed onto/into the still wet dispersion of adhesive layer 7 and pressed down lightly. The dispersion for adhesive layer 7 can also be in a lightly foamed state for an airless-sprayed application, or be used in the form of a mechanically blown foam. Applying all layers 4′, 4″ and 7 atop the die can be done particularly economically and leads to comparatively soft end products even in the case of fibrous nonwoven web backing layers.

In the case of loop-formingly knitted or woven fabric backing layers having a denser fibrous structure on their coating side, it is advantageous to apply the dispersion for the adhesive layer 7 directly to the textile material, preferably by spraying and especially by airless spraying.

It is advantageous when all layers 4′, 4″ and 7 are brought together or laid one against the other in the wet or moist state and are bonded/crosslinked together with the crosslinker present in them. This ensures that the layers 4′ and 4″ and also the adhesive layer 7 are bonded together firmly and durably even when the layers 4′, 4″ and 7 have been formed using different polyurethane dispersions.

In the context of the invention, the fibers/yarns may have different colors; that is, the textile backing layer 2 may also be configured/structured to be multicolored. This holds especially for loop-formingly knitted and woven fabric backings. The backing layer 2 may also be printed with textile dyes to be multicolored. In this case, according to the invention, the coating 4 could be transparent or colored in a transparent way which lets the colors of backing layer 2 remain visible.

When a loop-formingly knitted or woven fabric is bonded to a fibrous nonwoven web, the fibrous nonwoven web is advantageously always at least 0.3 to 1.3 mm thicker than the loop-formingly knitted or woven fabric to which it is mechanically or adhesively bonded in any way which ensures manipulation resistance at least.

Cut-to-size formats produced to be in accordance with the present invention had, versus comparable heavier commercially available materials, an improved durability coupled with a low weight; an enhanced abrasion resistance; and also an enhanced tensile strength; and outmatched these known materials with regard to softness and haptics. Parameters will now be recited for cut-to-size formats which all displayed essentially optimal performance characteristics while differing in overall thickness:

1. A cut-to-size format 1 was produced to have an overall basis weight of 370 g/m², while the overall basis weight of the backing layer was 240 g/m². The backing layer 2, produced using a loop-formingly knitted polyester fabric, had a fleecy reverse side and a thickness of 0.85 mm. The entire polyurethane content had a basis weight of 130 g/m². Adhesive layer 7 had a penetration depth into backing layer 2 of 0.03 mm. The dispersion forming adhesive layer 7 was applied directly atop the backing layer 2. The overall thickness of the cut-to-size format was 1.0 mm.

2. A cut-to-size format 1 having an overall basis weight of 400 g/m² was produced. The overall basis weight of backing layer 2 was 290 g/m². Backing layer 2 was produced using a woven polyamide fabric and had a fleecy reverse side coupled with a thickness of 0.9 mm. The entire polyurethane content was 110 g/m². The penetration depth of adhesive layer 7 into backing layer 2 was 0.04 mm. The dispersion forming adhesive layer 7 was applied directly atop the backing layer 2. The overall thickness of the cut-to-size format 2 was 1.15 mm.

3. A cut-to-size format 1 having an overall weight of 355 g/m² was produced. Backing layer 2 had an overall basis weight of 215 g/m². Backing layer 2 had a thickness of 1.35 mm and was produced using a wide-mesh loop-formingly knitted polyamide fabric reinforced with a fibrous nonwoven polyamide web having a thread linear density of 3 denier. The overall polyurethane content of the cut-to-size format was 140 g/m². The penetration depth of adhesive layer 7 into the backing layer was 0.08 mm. The dispersion of adhesive layer 7 was applied atop backing layer 2 indirectly; that is, backing layer 2 was placed on adhesive layer 7 while the latter was positioned in the die. The overall thickness of the cut-to-size format was 1.35 mm.

4. A cut-to-size format 1 having an overall basis weight of 330 g/m² was produced. The overall basis weight of backing layer 2 was 235 g/m². The thickness of backing layer 2 was 1.70 mm and was produced using a fibrous nonwoven polyester web having threads 3 denier in linear density. The entire polyurethane content of the cut-to-size format was 95 g/m². The penetration depth of adhesive layer 7 into backing layer 2 was 0.04 mm. The dispersion of adhesive layer 7 was applied atop backing layer 2 indirectly. The cut-to-size format has an overall thickness of 1.80 mm.

5. A cut-to-size format 1 having an overall basis weight of 380 g/m² was produced. The overall basis weight of backing layer 2 was 230 g/m². The thickness of the backing layer was 1.50 mm. Backing layer 2 was produced using a fibrous nonwoven polyester web whose threads had a linear density of 3 denier, this fibrous nonwoven web having applied to it a woven cotton fabric atop which coating 4 was applied. The penetration depth of adhesive layer 7 into backing layer 2 was 0.09 mm. Adhesive layer 7 was applied to backing layer 2 indirectly. The cut-to-size format has an overall thickness of 1.65 mm.

6. A cut-to-size format 1 having an overall basis weight of 395 g/m² was produced. The overall basis weight of backing layer 2 was 290 g/m², The thickness of backing layer 2 was 0.95 mm. Backing layer 2 was produced using a loop-formingly knitted polyester fabric admixed with cotton such that the loop-formingly knitted fabric contains 60 wt % of polyester and 40 wt % of cotton; the reverse side of the loop-formingly knitted fabric had been roughened to be fleecy. The overall polyurethane content was as 105 g/². The penetration depth of adhesive layer 7 into backing layer 2 was 0.03 mm. Adhesive layer 7 was applied indirectly. The overall thickness of the cut-to-size format was 1.15 mm.

7. A cut-to-size format 1 having an overall basis weight of 350 g/m² was produced. The overall basis weight of backing layer 2 was 285 g/m². Backing layer 2 had a thickness of 1.0 mm and was produced using a microfibrous nonwoven polyester web endowed with a sponge-type polyurethane incorporation. The entire polyurethane content was 138 g/m². Adhesive layer 7 penetrated into backing layer 2 by 0.025 mm. Adhesive layer 7 was applied atop backing layer 2 directly. The cut-to-size format had an overall thickness of 1.1 mm.

The polyurethane dispersions used in these cut-to-size formats have the parameters recited in the description.

All produced cut-to-size formats 1 meet the stated requirements. Bending results were worst for cut-to-size format 4 and best for cut-to-size formats 3, 5 and 7. Cut-to-size formats 1, 2, 3, 5, 6 and 7 did not show any noticeable surface changes even on elongation by 15%.

Cut-to-size formats 1 where the dispersion of adhesive layer 7 was applied atop the material of backing layer 2 indirectly had the better properties when all criteria are taken into account. These cut-to-size formats are also obtainable in a simpler and environmentally friendlier manner, since less energy is needed and the appearance of these cut-to-size formats is better. These advantages are more particularly attributable to backing layer 2 being placed on the still wet homogeneous layer 7 applied atop coating 4 in the die.

In a Shore A hardness test, a test specimen 5 mm in thickness is prepared beforehand from the particular polyurethane-containing dispersion mixture used, and tested for hardness.

Fibrous nonwoven webs where the fibers are in the denier range can be consolidated by mechanical needling or via hydroentangling or heat-setting, and are used in this consolidated form. Their fibers are always in a three-dimensional arrangement.

In microfibrous nonwoven webs, the fibers are cohered by incorporation in a wet, sponge-type layer of polyurethane. Nonwoven webs of this type imbibe at least twice their weight of water without dripping.

“Indirect” application of adhesive layer 7 is to be understood as meaning that a transfer, i.e., in the present case a die atop which the coating 4 or the layers 4′ and 4″ have already been formed, is used to contact the wet dispersion with the material of backing layer 2, precisely by applying backing layer 2 to the layers in the die.

By “direct application” is meant that the dispersion of adhesive layer 7 is applied directly atop backing layer 2.

A low downward pressure is to be understood as meaning a pressure which a pressure cylinder having a diameter of more than 300 mm exerts with its resilient sheath on the material of backing layer 2. The maximum pressure is preferably 0.3 kg/cm² and more preferably 0.1 kg/cm².

FIG. 4 depicts a particularly advantageous embodiment of a cut-to-size format that is in accordance with the present invention. Backing layer 2 in this cut-to-size format is a loop-formingly knitted or woven fabric combined with a fibrous nonwoven web 6. The loop-formingly knitted or woven fabric has a thin and/or wide-meshed configuration. Especially indirect application of backing layer 2 atop the coating mass/polyurethane layers 4′ and 4″ in the die results in the wet polyurethane dispersion being forced through the open/wide-mesh loop-formingly knitted or woven fabric, and the dispersion penetrates into the fibrous nonwoven web 6 or to be more precise into the surface regions 3 of fibrous nonwoven web 6. The wide-mesh loop-formingly knitted or woven fabric backing 2 has thus been embedded into the adhesive layer 7, between the fibrous nonwoven web 6 and the coating 4.

It is preferable for all layers of polyurethane dispersion to be applied atop the die. The chemistry and composition of coating 4 and of layer 4″ as adhesive layer are preferably identical. In indirect application, the transfer, i.e., backing layer 2, can be placed directly into the fully wet layer 4″, especially without being polyurethane coated and especially in the case of extremely absorbent textiles. In this case, the layer 4″ also comprises the chemistry for the otherwise provided adhesive layer 7, since the layer 4″ penetrates into the backing layer 2 directly and in a controlled manner. A separate or separately applied adhesive layer 7 can be omitted in this case.

The broken-line hatching in FIG. 4 indicates the polyurethane adhesive layer 4″ or 7 which embeds the woven or loop-formingly knitted fabric 2 and which has penetrated into the fibrous nonwoven web 6 in region 3 and bonds the layer 4′ or the coating 4 to the fibrous nonwoven web 6.

FIG. 5 depicts a cut-to-size format which is comparable to the cut-to-size format depicted in FIG. 1. Backing material 2 attaches on its reverse side to a layer 6 comprising a layer 8 formed using a peelable foam of polyurethane or a chloroprene/polyprene polymer foam or a needlefelt or a fibrous nonwoven polyester or polyamide web, which layer 8 is bonded to a loop-formingly knitted fabric 9.

To obtain a light yet also thick cut-to-size format, it may be provided that the further layer 6 is more than twice as thick as the backing material 2 and has a basis weight of 40 to 60% of the overall basis weight of backing material 2.

Particularly good results regarding strength, lightness and robustness are obtained when the peelable polyurethane foam 8 or the chloroprene foam has a density of 0.005 to 0.12 g/cm³ and preferably of 0.01 to 0.06 g/m³ and optionally an average thickness of 2 to 4 mm and preferably of 2.5 to 3.5 mm, and/or when the needlefelt used as layer 8 has a basis weight of 100 to 200 g/m² and preferably of 120 to 160 g/m² and an average thickness of 2 to 4 mm and preferably of 2.5 to 3.5 mm, and/or when the loop-formingly knitted fabric 9 forming the reverse side has a basis weight of 60 to 160 g/m² and preferably of 80 to 100 160 g/m².

The entire cut-to-size sheet contains altogether a low amount of polyurethane when the basis weight of peelable polyurethane foam 8 is a portion of the basis weight of the entire polyurethane content of cut-to-size format 1. A cut-to-size format which is in accordance with the present invention by including an additional layer 6 as well as depicted in FIG. 5 is advantageously characterized in that the layer 6 is attached to the reverse side of said backing layer 2, and that optionally for an overall thickness of 0.9 to 6 mm and preferably 2 to 5 m, the overall weight of said cut-to-size format 1, especially inclusive of said at least one layer 6 attached to said reverse side of said backing material 2, is between 250 and 600 g/m² and especially between 270 and 550 g/m².

The embodiment depicted in FIG. 5 is particularly advantageous for use in automotive roof liners/automotive interior trim, children's seats in vehicles, and also vehicle seat covers or parts thereof. A cut-to-size format of this type has the desired thickness coupled with low weight; pleasant haptics; and is highly noise-deadening while providing a very good cushioning effect. The fact that a weight reduction has been achieved for a cut-to-size format in vehicles compared with known materials also has immense significance in order to reduce the CO₂ output and save propulsive energy, as is important in the case of electrically operated vehicles in particular. These properties are also advantageous for use as a shoe upper material.

To produce a cut-to-size format as per FIG. 5, a textile backing material 2 is attached to the layer 6 and the cut-to-size format attains a thickness between 2 to 5 mm for a basis weight in the range from 270 to 550 g/m². The construction of the cut-to-size format comprises a woven or loop-formingly knitted fabric which in addition to synthetic fibers contains up to 50 wt % of cotton fibers. The bulky layer 6 is attached to this backing material 2 with a synthetic fibrous nonwoven web or needlefelt or a light peelable polyurethane foam or chloroprene-polymer foam. The sub-layer or reverse side of cut-to-size format 1 comprises the loop-formingly knitted fabric 9. The bulky fibrous nonwoven web or foam layer 8 is preferably more than twice as thick as the backing material 2 produced using a light woven or loop-formingly knitted fabric, and accounts for at most 50 wt % of the overall basis weight of the backing material. In order that bonding/laminating materials for bonding the individual layers together may be dispensed with, the different layers are advantageously bonded together directly in the course of producing the fibrous nonwoven web. When the layer 8 consists of a peelable polyurethane foam more than 2 mm in thickness, the textile backing layer 2 and the layer formed by a loop-formingly knitted fabric 9 can be bonded to the peelable polyurethane foam by conventional flame lamination. In the case of chloroprene foams, the loop-formingly knitted fabric 9 can be bonded to the foam as the foam is being produced. The peelable polyurethane foam and the chloroprene foam each have a density of 0.005 to 0.12 g/cm³ and preferably of 0.01 to 0.06 g/cm³. It is also possible in principle to increase the thickness of layer 8 or of the layer formed using the loop-formingly knitted fabric 9 to produce even thicker cut-to-size formats which do not exceed a basis weight of 600 g/m² at a thickness of 5 mm. A basis weight of 600 g/m² is usually not exceeded at even greater thicknesses, since the basis weights of the peelable polyurethane foam or chloroprene foam used or of a needlefelt used are very low.

The overall polyurethane content of the cut-to-size format provided with a layer 6 in accordance with FIG. 5 remains virtually unchanged, since layer 8 is produced using a peelable polyurethane foam and this foam is very light. Flame lamination is used to bond the textile backing layer 2 and the loop-formingly knitted fabric 9 together, and so no further adhesive is required.

In the case of chloroprene foams, the layer 8 is preferably bonded to the layer 9 at the same time as layer 8 as the chloroprene foam is produced. It is possible for backing layer 2 to be likewise hindered to layer 8 or the chloroprene foam in the course of the foam's production, without additional adhesives or adhesive compositions.

When the light bulky layer 8 is formed using a needlefelt, it could be possible for at least the loop-formingly knitted fabric 9 and where applicable also the loop-formingly knitted fabric of backing layer 2 to be bonded to the fibrous nonwoven web of layer 8 even as it is being produced. Therefore, there is again no need to use additional adhesive and especially no polyurethane adhesive composition. Therefore, the very positive weight ratio between the textile backing material and the entire polyurethane content of a cut-to-size format does not change from its low value.

This weight saving for otherwise appropriate strength and durability properties is an essential criterion for such cut-to-size sheets to be used in motor vehicles. The construction of a cut-to-size format as per FIG. 5 will now be more particularly elucidated using examples.

8. A cut-to-size format 1 was produced with an overall basis weight of 560 g/m². The overall basis weight of backing layer 2 was 410 g/m². The overall thickness of the cut-to-size format formed using layers 2 and 6 was 3.8 mm. Backing layer 2 was produced by using a loop-formingly knitted fabric with 50 wt % of cotton fibers and 50 wt % of polyester fibers. The basis weight of this loop-formingly knitted fabric was 205 g/m². The attached fibrous nonwoven web 8 was formed using polyester fibers and had a basis weight of 110 g/m². The loop-formingly knitted fabric 9 used for layer 6 and situated on the reverse side of the cut-to-size format was formed using polyester fibers and had a basis weight of 95 g/m². The light loop-formingly knitted fabrics were needle bonded to the fibrous nonwoven web as the fibrous nonwoven web was being produced. The entire basis weight of the polyurethane in the cut-to-size format was 150 g/m². This produced bonded textile assembly was placed with its surface on the wet adhesive composition 7 on the die and pressed down lightly. The cut-to-size format provided with coating 4 then had an overall thickness of 3.95 mm.

9. A cut-to-size format I having an overall basis weight of 530 g/m² was produced. The overall basis weight of the three-layered backing layer 2 was 390 g/m². The overall thickness of the cut-to-size format was 3.5 mm. It was formed by bonding a loop-formingly knitted polyester fabric having a basis weight of 185 g/m² and forming the surface to a layer 6 comprising a peelable polyurethane foam having a basis weight of 110 g/m². The under side of the cut-to-size format was formed by a loop-formingly knitted polyester fabric 9 having a basis weight of 95 g/m². The two loop-formingly knitted fabrics, i.e., the loop-formingly knitted fabric of backing layer 2 and the loop-formingly knitted fabric 9, were bonded to the peelable polyurethane foam 8 using flame lamination. To bond the coating 4 to the backing layer 2, adhesive composition 7 was applied half in the die to form the adhesive layer 4′ and half atop the surface of the loop-formingly knitted fabric of backing layer 2 to form the layer 4″. The two layers were brought together in the moist state. The entire polyurethane content of the cut-to-size format had a basis weight of 230 g/m². The overall thickness of the cut-to-size format was 4.3 mm.

10. A cut-to-size format 1 having an overall basis weight of 560 g/m² and a thickness of 3.25 mm was produced using a chloroprene-polymer foam two millimeters in thickness and having a density of 0.06 g/cm³, which was bonded on its upper side to a loop-formingly knitted polyester fabric having a basis weight of 120 g/m² and on its reverse side to a loop-formingly knitted polyester fabric having a basis weight of 65 g/m².

This chloroprene-polymer foam layer 8, having a loop-formingly knitted fabric provided on both sides, was bonded with an adhesive to the reverse side of backing layer 2 which consisted of a woven cotton/polyester fabric and had a basis weight of 160 g/m². The polyurethane coating had a basis weight of 115 g/m² and had soaked into the backing material by about 0.04 mm.

What is claimed is:

1. A cut-to-size format comprising a more particularly sheeting-shaped or layer-shaped backing material (2) comprising a fibrous nonwoven web and/or loop-formingly knitted and/or woven fabric comprising polyamide and/or polyester threads, more particularly polyamide and/or polyester microfibers and/or cotton threads and, applied atop said backing material (2), a coating (4) comprising polyurethane dispersion on a patterned silicone rubber support/mold attached to said backing material (2), optionally via an adhesive layer (7) comprising polyurethane dispersion, characterized in that
the entire polyurethane content of said cut-to-size format (1) is in the range from 60 to 240 g/m², preferably in the range from 80 to 150 g/m² and especially in the range from 100 to 140 g/m², this basis weight also including any polyurethane already present in said backing material (2) or introduced thereinto in the course of production thereof, and
the basis weight of said backing material (2) including where applicable any polyurethane present therein, is in the range from 200 g/m² to 450 g/m², preferably in the range from 200 g/m² to 350 g/m² and especially in the range from 230 g/m² to 270 g/m².

2. The cut-to-size format of claim 1, characterized in that said coating (4), which is more particularly applied in the form of a film, has a basis weight in the range from 60 g/m² to 240 g/m² and preferably in the range from 60 g/m² to 160 g/m².

3. The cut-to-size format of claim 1 or 2, characterized in that the loop-formingly knitted or woven fabric are in a tumbled and/or lightly buffed state, optionally emeried with a grit size >400, especially with a grit size of 450 to 900.

4. The cut-to-size format of any of claims 1 to 3, characterized in that said backing material (2) comprises visually dense, i.e., scarcely or minimally transparent and/or non-translucent loop-formingly knitted or fibrous nonwoven web or woven fabrics or, optionally, fibrous nonwoven webs with loop-formingly knitted or woven fabric layers on top, wherein the fibrous nonwoven webs consist of synthetic fibers and the loop-formingly knitted or woven fabric consists of cotton fibers.

5. The cut-to-size format of any of claims 1 to 4, characterized in that the side of said backing material (2) which is remote from said coating (4) has at least one further layer (6), preferably comprising a light, bulky fibrous nonwoven polyester or polyamide web adhered to or laminated onto it with a foamed polymeric dispersion adhesive.

6. The cut-to-size format of any of claims 1 to 5, characterized in that said backing material (2) comprises not more than 30 wt %, preferably not more than 20 wt %, of the total amount of solidified polyurethane dispersion present in said cut-to-size format (1).

7. The cut-to-size format of any of claims 1 to 6, characterized in that said adhesive layer (7) comprising polyurethane dispersion has soaked/penetrated into said backing layer (2) by from 0.02 to 0.6 mm and preferably by from 0.05 to 0.4 mm.

8. The cut-to-size format of any of claims 1 to 7, characterized in that the regions (3) of said backing material (2) into which the polyurethane dispersion of said adhesive layer (7) has penetrated in a controlled manner on application have a density which is between 15% and 55% and preferably between 20 and 35% above the density of the remaining/polyurethane-free regions of said backing material (2).

9. The cut-to-size format of any of claims 1 to 8, characterized in that said adhesive layer (7) has been applied atop/incorporated into said backing material (2) at from 20 to 80 g/m², wherein optionally said adhesive layer (7) has been applied to said backing material (2) directly, especially by spraying, or the bonding of said adhesive layer (7) to said backing material (2) has been effected indirectly by placing/inlaying the layer of said backing material (2) onto said adhesive layer (7).

10. The cut-to-size format of any of claims 1 to 9, characterized in that said coating (4) is constructed with two inseparably interconnected layers and comprises a surficially positioned, surficially patterned layer (4′) comprising polyurethane dispersion, and a layer (4″) thereunder and connected therewith and comprising a polyurethane dispersion which possesses a linear structure and optionally contains polyacrylates and/or synthetic resins, wherein optionally to improve the bond between said layer (4″) comprising polyurethane dispersion and said backing material (2) there is provided between said polyurethane dispersion layer (4″) and the surface of said backing material (2) said adhesive layer (7) comprising polyurethane and at least partly soaked into this backing layer.

11. The cut-to-size format of any of claims 1 to 10, characterized in that said adhesive layer (7) comprises a polyurethane dispersion layer having a basis weight of 20 to 80 g/m² and optionally containing polyacrylates and/or synthetic resins and preferably possesses a chemical construction which is the same as or very similar to said polyurethane dispersion layer (4″).

12. The cut-to-size format of any of claims 1 to 11, characterized in that said adhesive layer (7) comprising polyurethane dispersion has soaked into said backing material (2) to not more than 10 to 40% and preferably 10 to 20% of the thickness of said backing material (2).

13. The cut-to-size format of any of claims 1 to 12, characterized in that there is a pattern on the surface of said coating (4), wherein said patterned coating (4) has the appearance of buffed parts of foamed plastic, buffed rubber, emery paper or waffling or of an industrial fabric, for example a loop-formingly woven or knitted fabric comprising glass or carbon fibers, or a technical appearance or a velour pattern or an appearance like grained leather or nubuck.

14. The cut-to-size format of any of claims 1 to 13, characterized in that said surface of said coating (4) has a very thin, hydrophobic finish layer (5) in a thickness of less than 0.005 mm with nanoparticles of polysiloxane or of wax or of fluoropolymers or of mixtures thereof.

15. The cut-to-size format of any of claims 1 to 14, characterized in that said coating (4) was produced on a silicone die and applied atop said backing material (2) and taking together with said adhesive layer (7) and any polyurethane present in said backing material (2) at the most does not contain any organic solvents, especially those used in the production of polyurethane, and is free of such organic solvents.

16. The cut-to-size format of any of claims 1 to 15, characterized in that the reverse side of said backing material (2) has a nonwoven polyester web containing threads/fibers comprising PET bottle regenerate attached/adhered to it with a foamed dispersion adhesive.

17. The cut-to-size format of any of claims 1 to 16, characterized in that said coating (4) comprising said layers (4″) and said layer (4″) is formed with a negatively patterned support/mold of silicone rubber by solidifying a polyurethane-containing dispersion and said surface of said coating (4) is produced/patterned with this die.

18. The cut-to-size format of claim 17, characterized in that said coating (4) applied atop said adhesive layer (7) was applied in the still moist state, in particular largely pressurelessly and with a temperature of not more than 80° C.

19. The cut-to-size format of any of claims 1 to 18, characterized in that said cut-to-size format (1) is in the form of a flexible, sheetlike structure, especially in plate-shaped pieces.

20. The cut-to-size format of any of claims 1 to 19, characterized in that at least one further layer (6) is attached to the reverse side of said backing layer (2), and that optionally for an overall thickness of 0.9 to 6 mm and preferably 2 to 5 m, the overall weight of said cut-to-size format (1), especially inclusive of said at least one layer (6) attached to said reverse side of said backing material (2), is between 250 and 600 g/m² and especially between 270 and 550 g/m².

21. The cut-to-size format of any of claims 1 to 20, characterized in that said coating (4) comprises a polyurethane dispersion having a hardness of less than 68 Shore A and preferably of less than 55 Shore A.

22. The cut-to-size format of any of claims 1 to 21, characterized in that the fibers of said fibrous nonwoven web comprise polyester and/or polyamide and/or cotton, and/or in that the yarns/threads of said loop-formingly knitted or woven fabric comprise polyester and/or polyamide with or without a proportion of up to 40 wt % and preferably up to 45 wt % of cotton or cotton threads, and/or exclusively cotton or cotton threads.

23. The cut-to-size format of any of claims 1 to 22, characterized in that said coating (4) comprises a solidified polyurethane dispersion mixture which contains between 2 and 10 wt % of non-emigratable polysiloxane and is crosslinked.

24. The cut-to-size format of any of claims 1 to 23, characterized in that said adhesive layer (7) comprises 50 to 85 wt % of crystalline polyurethane and is crosslinked, and/or has soaked/become embedded into the absorbent backing material (2) of said cut-to-size format (1) from the material surface, directly or indirectly, to a depth of 0.02 to 0.6 mm and especially 0.05 to 0.4 mm measured from the surface, and/or in that said adhesive layer (7) has been applied atop said backing material (2) from the surface at a weight of 20 to 80 g/m² and has become at least partly incorporated therein.

25. The cut-to-size format of any of claims 1 to 24, characterized in that said layer (4″) acting as adhesive layer, and/or said adhesive layer (7) each contain up to 50 wt % and preferably up to 25 wt % of polyacrylates and each have a hardness of less than 48 Shore A and preferably a hardness between 20 and 35 Shore A.

26. The cut-to-size format of any of claims 1 to 25, characterized in that the conjoint overall thickness of said surface layer (4) and said adhesive layer (7) is in the range from 0.05 to 0.65 mm.

27. The cut-to-size format of any of claims 1 to 26, characterized in that all layers of said coating (4) and of said adhesive layer (7) contain a crosslinker and the individual layers are mutually crosslinked by being joined together in the still moist state.

28. The cut-to-size format of any of claims 1 to 27, characterized in that a loop-formingly knitted or woven polyester or polyamide fabric contains between 10 and 45 wt % and preferably between 20 and 30 wt % of cotton threads, and/or in that loop-formingly knitted or woven cotton fabrics have a basis weight between 100 g/m² and 200 g/m² and any fibrous nonwoven web optionally bonded to these wovens or formed-loop knits has a basis weight of 100 g/m² to 200 g/m².

29. The cut-to-size format of any of claims 1 to 28, characterized in that the polyurethane dispersions used are resin modified, and/or in that the polyurethane dispersion of said coating (4) and/or of said adhesive layer (7) contains from 2 to 9 wt %, based on the total weight of said polyurethane dispersion, of synthetic resins or to be more precise of synthetic resins possessing contact adhesive type properties.

30. The cut-to-size format of any of claims 1 to 29, characterized in that said surface of said coating (4) comprises at least two different regions as regards texture and/or frictions and/or appearance.

31. The cut-to-size format of any of claims 1 to 30, characterized in that said backing layer (2)/said backing material comprises two different interconnected textiles, for example a loop-formingly knitted fabric connected to a fibrous nonwoven web or a woven fabric connected to a fibrous nonwoven web, wherein the less extensible, thin textiles have a wide-mesh structure and are close to said coating (4), or to be more precise said coating (4) is applied atop these less extensible textiles, or wherein the less extensible textiles are largely or wholly embedded into said adhesive layer (7).

32. The cut-to-size format of any of claims 1 to 31, characterized in that
the wovens or formed-loop knits of said backing layer (2)/backing material display a fleecy fibrous structure on their face away from said coating (4), and/or in that
when said backing layer (2) comprises different layers of woven, loop-formingly knitted and/or fibrous nonwoven web fabrics, the layer closer to said coating (4) is less extensible and an employed fibrous nonwoven web forms the underside of said backing layer (2) as a soft and light constituent part of said backing layer (2).

33. The cut-to-size format of any of claims 1 to 32, characterized in that all layers (4, 4′, 4″ and 7) were brought together or to be more precise laid on top of one another in the wet or moist state and bonded/crosslinked together by the crosslinker they contain.

34. The cut-to-size format of any of claims 1 to 33, characterized in that said backing material (2) comprises colored or to be more precise differently colored fibers or yarns and/or is color printed, and/or in that said material of said coating (4) is transparent or transparently colored.

35. The cut-to-size format of any of claims 1 to 34, characterized in that said coating (4) contains up to 4 wt % of transparent hollow microspheres comprising plastics material.

36. The cut-to-size format of any of claims 1 to 35, characterized in that said polyurethane dispersions/polyurethane dispersion mixtures contain solids in the form of pigments, crosslinkers and/or thickeners, and/or in that
said backing layer (2) contains chemicals influencing the softness and/or surface tension and/or fire behavior of the textile material used.

37. The cut-to-size format of any of claims 1 to 36, characterized in that said backing layer (2)/backingmaterial comprises a fibrous nonwoven web whereatop a wide-mesh, open woven or loop-formingly knitted fabric has been applied, wherein said adhesive layer (7) or said layer (4″) has penetrated through said woven or loop formingly knitted fabric to soak or be incorporated into the surface regions of said fibrous nonwoven web.

38. The cut-to-size format of any of claims 1 to 37, characterized in that said further layer (6) comprises a bonded assembly formed by a needlefelt (8) or fibrous nonwoven polyester/polyamide web (8) or a layer of a peelable polyurethane foam (8) or a chloroprene-polymer foam (8) with a loop-formingly knitted fabric (9) and attached to said reverse side of said backing material (2), which is preferably formed by a loop-formingly knitted fabric.

39. The cut-to-size format of claim 38, characterized in that said further layer (6) is more than twice as thick as said backing material (2) and has a basis weight equal to 20 to 40% of the overall basis weight of said backing material (2).

40. The cut-to-size format of claim 38 or 39, characterized in that said peelable polyurethane foam (8) or said polychloroprene foam (8) possesses a density of 0.005 to 1.2 g/cm³, preferably 0.01 to 0.06 g/cm³, and/or in that said needlefelt (8) possesses a basis weight of 100 to 200 g/m², preferably 120 to 160 g/m², and an average thickness of 2 to 4 mm, preferably 2.5 to 3.5 mm, and/or in that said loop-formingly knitted fabric (9) which forms said reverse side possesses a basis weight of 60 to 160 g/m², preferably 80 to 120 g/m², especially 80 to 100 g/m².

41. The cut-to-size format of any of claims 1 to 40, characterized in that said basis weight of said peelable polyurethane foam (8) is part of said basis weight or of said entire polyurethane content of said cut-to-size format (1).

42. The use of a cut-to-size format (1) of any of claims 1 to 41 to produce articles in the form of motor vehicle inside wall lining and cushioning, bags, suitcases, furniture covers, garments, shoes, bicycle or motorbike saddles or map cases, or an article obtained using a cut-to-size format of this type.
